(19) United States
(12) Patent Application Publication
(10) Pub. No.: US 2016/0318703 A1
(43) Pub. Date: Nov. 3, 2016

(54) Beverage Capsule

(71) Applicant: Manuel Macias, San Diego, CA (US)

(72) Inventor: Manuel Macias, San Diego, CA (US)

(21) Appl. No.: 15/144,268

(22) Filed: May 2, 2016

Related U.S. Application Data
(60) Provisional application No. 62/155,546, filed on May 1, 2015.

(51) Int. Cl. B65D 85/804; A23L 2/56

(52) U.S. Cl. CPC B65D 85/8043; A23L 2/56; A23V 2002/00

(57) ABSTRACT

A beverage capsule for flavoring a food product. The beverage capsule includes a shell encompassing a core of edible flavoring material. The shell is an ingestible and non-toxic water soluble material. In one embodiment, the edible material is selected from the following group consisting of polyvinyl alcohol, gelatin, pectin, waxes, gums, and sugar. The core is an ingestible material used to flavor beverages such as coffee, tea, and water. In one embodiment, the shell is impregnated with an edible material such as artificial sweetener, sugar, and syrup.

### CROSS REFERENCE TO RELATED APPLICATION

This application claims the benefit of U.S. Provisional Application No. 62/155,546 filed on May 1, 2015. The above identified patent application is herein incorporated by reference in its entirety to provide continuity of disclosure.

### BACKGROUND OF THE INVENTION

The present invention relates to a beverage capsule. More specifically, the present invention relates to a dissolvable beverage capsule which includes edible material for flavoring beverages such as coffee, tea, water, and the like.

Many people add cream or other flavoring agents to coffee, tea, and the like for their enjoyment. These flavoring agents are typically packaged in small increments or provided in larger containers. They generally allow for individual or communal usage, and are not combined with other flavoring agents. For example, granulated sugar or artificial sweetener are stored in small packets that are usually spilled while transferring and require disposal of the left over empty packet.

These conventional containers face serious deficiencies when dispensing flavoring agents from large containers. For example, it can be difficult to judge how much of the flavoring agent is needed or dispensed to the food product. Often measuring devices are required to measure out a specific amount of flavoring agent. Further, these large containers and measuring devices can cause flavoring agents to be spilled and at least some remains within the containers. Thus, it is desirable to provide a flavoring agent having a predefined amount of substance for flavoring a food product, thereby also eliminating waste.

In addition, these known aforementioned containers, however, fail to disclose a flavoring beverage capsule having a water soluble shell encompassing a core of edible flavoring material. Further, these attempts fail to provide a flavoring agent having a water soluble shell having sugar impregnated therein. Thus, it is desirable to provide a flavoring beverage capsule which is easily added to a beverage by a user as desired.

In light of the devices disclosed in the prior art, it is submitted that the present invention substantially diverges in design elements from the prior art and consequently it is clear that there is a need in the art for an improvement to existing beverage capsules. In this regard the instant invention substantially fulfills these needs.

### SUMMARY OF THE INVENTION

In view of the foregoing disadvantages inherent in the known types of beverage capsules now present in the prior art, the present invention provides beverage capsule wherein the same can be utilized for flavoring a beverage.

It is therefore an object of the present invention to provide a new and improved beverage capsule that has all of the advantages of the prior art and none of the disadvantages.

The present invention relates to a beverage capsule comprising a shell of a first edible material and a core of a second edible material, wherein the edible materials are used to flavor beverages such as coffee, tea, water, and the like.

It is therefore an object of the present invention to provide a beverage capsule in the form of a teardrop comprising an ingestible flavor and sweetener.

Yet another object of the present invention is to provide a beverage capsule having a shell that further comprises a third edible material impregnated therein, wherein the third edible material may include artificial sweetener, sugar, and syrup.

Further, another object of the present invention to provide a beverage capsule that is dissolvable in a liquid at a temperature in the range of 140° F. to 450° F.

Finally, another object of the present invention to provide a beverage capsule that enables users to select and dispense an exact number of capsules.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of one embodiment of the present invention.

FIG. 2 shows a cross sectional view of one embodiment of the present invention taken along line 2-2 of FIG. 1 of the present invention.

FIG. 3A shows a perspective view of a cubical embodiment of the present invention.

FIG. 3B shows a perspective view of a pyramidal embodiment of the present invention.

FIG. 3C shows a perspective view of a spherical embodiment of the present invention.

### DETAILED DESCRIPTION OF THE INVENTION

Reference is made herein to the attached drawings. Like reference numerals are used throughout the drawings to depict like or similar elements of the beverage capsule. For the purposes of presenting a brief and clear description of the present invention, the preferred embodiment will be discussed as used for flavoring beverages such as coffee, tea, water, and the like. The figures are intended for representative purposes only and should not be considered to be limiting in any respect.

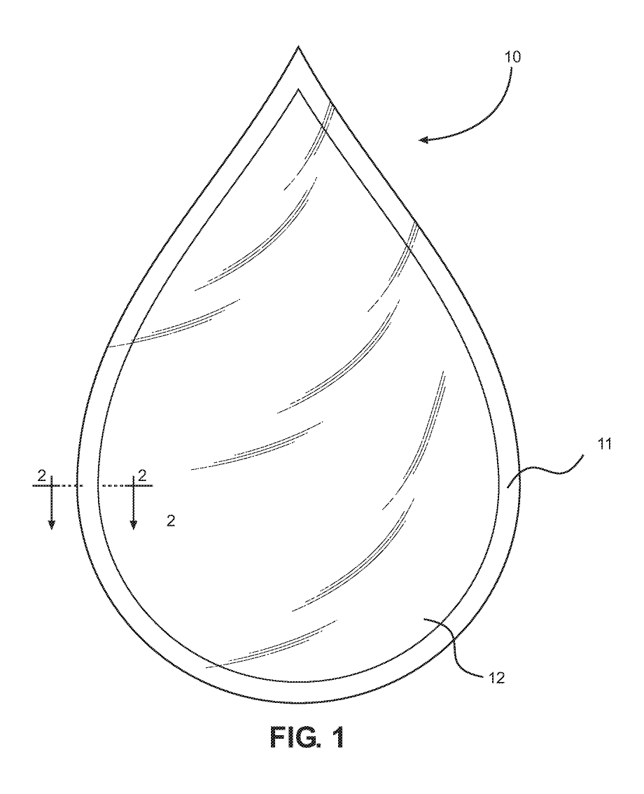

Referring now to FIG. 1, there is a shown perspective view of one embodiment of the present invention. The present invention provides a beverage capsule 10 for flavoring beverages such as coffee, tea, water, and the like. The beverage capsule 10 comprises a shell 11 that encompasses a core 12, wherein the shell 11 includes a first edible material that is an ingestible and non-toxic solute that is dissolvable in a solvent, such as water. In one embodiment, the first edible material is water soluble. Further, the first edible material is selected from the following group consisting of polyvinyl alcohol, gelatin, pectin, waxes, gums, and sugar. The core 12 includes an interior volume configured to house a second edible material, wherein the second edible material may be a flavor agent in a liquid or solid form. The second edible material will be retained in clean environment until the beverage capsule is used.

In a preferred embodiment, the interior volume of the core 12 is configured to hold approximately 0.5 ounces of the second edible material. In one embodiment, the second edible material is selected from the following group consisting of dairy creamer, nondairy creamer, and sweetener.

In one embodiment, the beverage capsule 10 will release the second edible material from the core 12 within five seconds and sixty seconds after contacting a liquid medium. The second edible material may be released by the dissolving, rupturing, and the like of the shell 11. The shell 11, being a made from the first edible material, allows for rapid dissolution thereof and the intermixing of the second edible material with the beverage.

In the shown embodiments, the beverage capsule 10 is in the form of a teardrop. However, in alternative embodiments, the beverage capsule 10 may be shaped spherically or non-spherically, such as a cube or pyramid. The shape of the beverage capsule 10 affects the rate at which the shell 11 dissolves or otherwise releases the core 12. Further, the exterior surface area of the shell 11 and temperature of the beverage affects the diffusion rate of the water soluble first edible material to the beverage. The teardrop shape provides an aerodynamic shape that minimizes splashing upon contacting the surface of fluid.

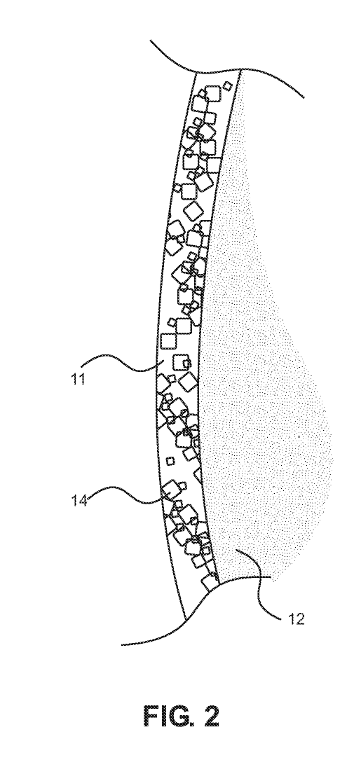

Referring now to FIG. 2, there is a shown cross sectional view of one embodiment of the present invention taken along line 2-2 of FIG. 1 of the present invention. In the shown embodiment, the shell 11 further comprises a third edible material 14 impregnated therein. The third edible material is selected from the following group consisting of artificial sweetener, sugar, and syrup. The third edible material 14 is impregnated in an approximately uniform distribution through the shell 11. However, in alternative embodiments, the distribution may vary significantly to include denser areas of the third edible material 14. The third edible material 14 provides an additional way of flavoring beverages with a known serving size. In one embodiment, the ratio in volume of the third edible material 14 to the shell 11 is between 1:20 to 1:1.

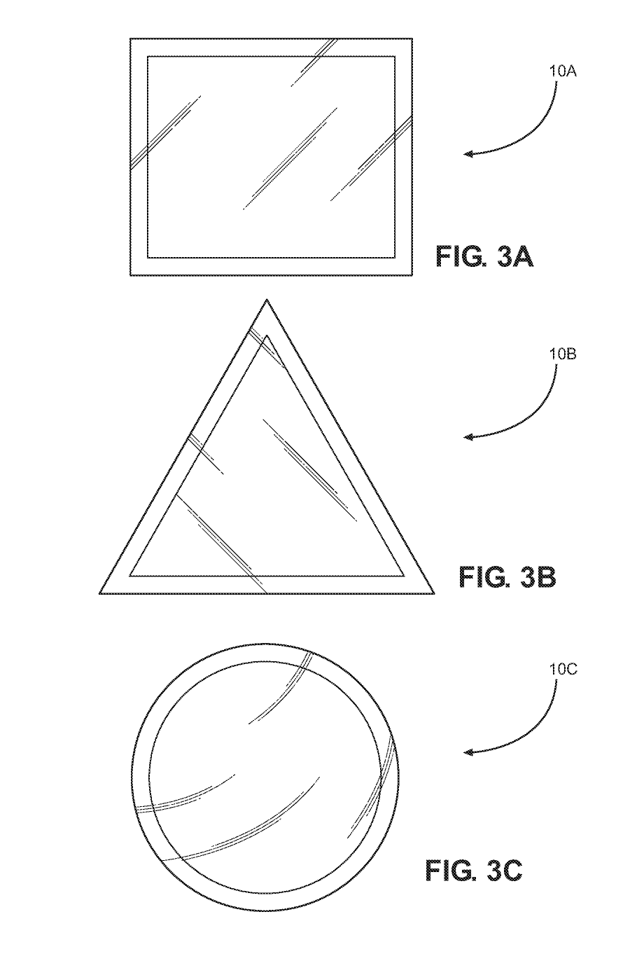

Referring now to FIGS. 3A-3C, there is a shown view of a cubical. pyramidal, and spherical embodiment of the present invention, respectfully. In the spherical embodiment, the ratio of shell surface area to core is minimized, thereby providing a relatively high amount of second edible material per beverage capsule 10. The beverage capsule 10 may also be made with indentations to provide a greater surface area, and thereby causing a greater dissolving rate in hot fluid. Alternatively, the shape of the cubical and pyramidal embodiments of the beverage capsule 10 may provide greater structural support for the shell in use and storage.

In one use, one or more beverage capsules 10 are added to a cup containing a hot coffee (or similar liquid medium) generally having a temperature in the range of 140° F. to 450° F. The shell of the beverage capsule 10 begins to dissolve with the coffee until the shell ruptures and causes the second edible material of the core to be released into the coffee. The shell does not require stirring or agitation to dissolve; however stirring or agitation may speed up the dissolution. The second edible material intermixes with the coffee to provide a desired flavor. The user can readily customize their serving of beverage to the desired flavor concentration and ration by increasing the number of beverage capsule 10 to the beverage. In one embodiment, one to eight beverage capsule 10 are added to an eight ounce beverage to achieve desirable flavor levels.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A beverage capsule comprising:
a shell of a first edible material;
wherein the first edible material of the shell is a solute;
a core of a second edible material disposed within the shell;
wherein the second edible material of the core is a flavor agent.

2) The beverage capsule of claim 1, wherein:
the first edible material of the shell is selected from the following group consisting of polyvinyl alcohol, gelatin, pectin, waxes, gums, and sugar candies.

3) The beverage capsule of claim 1, wherein:
the second edible material of the core is selected from the following group consisting of dairy creamer, nondairy creamer, and sweetener.

4) The beverage capsule of claim 1, wherein:
the shell is teardrop shaped.

5) The beverage capsule of claim 1, wherein:
the shell is cubical.

6) The beverage capsule of claim 1, wherein:
the shell is spherical.

7) The beverage capsule of claim 1, wherein:
the shell further comprises a third edible material impregnated in the shell.

8) The beverage capsule of claim 7, wherein:
the third edible material is selected from the following group consisting of artificial sweetener, sugar, and syrup.

9) The beverage capsule of claim 1, wherein:
the second edible material comprises 0.5 ounces by volume.

10) The beverage capsule of claim 1, wherein:
the ratio by weight of the first edible material to the second edible material ranges from 1:20 to 20:1.

11) The beverage capsule of claim 1, wherein:
the first edible material of the shell is dissolvable in fluid at a temperature in the range of 140° F. to 450° F.

12) The beverage capsule of claim 1, wherein:
the first edible material of the shell is water soluble.

13) A beverage capsule comprising:
a shell of a first edible material;
wherein the first edible material of the shell is dissolvable at a temperature in the range of 140° F. to 450° F.;
a core of a second edible material disposed within the shell;
wherein the second edible material of the core is selected from the following group consisting of dairy creamer, nondairy creamer, and sweetener.
